(19) United States
(12) Patent Application Publication
(10) Pub. No.: US 2005/0218009 A1
(43) Pub. Date: Oct. 6, 2005

(54) Electrochemical planarization system and method of electrochemical planarization

(76) Inventors: Jinshan Huo, Naperville, IL (US); James McAndrew, Homer Glen, IL (US); Rajendra Solanki, Portland, OR (US)

Correspondence Address: AIR LIQUIDE, 2700 POST OAK BOULEVARD, SUITE 1800, HOUSTON, TX, 77056, US

(21) Appl. No.: 11/025,644

(22) Filed: Dec. 29, 2004

Related U.S. Application Data
(60) Provisional application No. 60/558,939, filed on Apr. 2, 2004.
(60) Provisional application No. 60/591,493, filed on Jul. 27, 2004.

(51) Int. Cl. B23H 5/00

(52) U.S. Cl. 205/663

(57) ABSTRACT

Improved electrochemical planarization of an anode surface is performed by rotating either an anode or a cathode and applying a voltage therebetween. The cathode has a surface facing the anode and is configured such that the surface does not extend over all of the anode surface to be planarized during rotation of the anode or cathode. Preferably, the anode is a patterned or unpatterned semiconductor wafer with electroplated metal thereon, such as copper.

### CROSS-REFERENCE TO RELATED APPLICATIONS

This application claims the benefit under 35 U.S.C. § 119(e) to provisional application No. 60/558,939 filed Apr. 2, 2004, and provisional application 60/591,493 filed Jul. 27, 2004, the entire contents of which are incorporated herein by reference.

### BACKGROUND

Copper damascene is the most common technique used to produce interconnects for ULSI circuits. To meet the challenges of continuing increase of device speed and shrinkage of device dimensions, one of the strategies used is to use ultra low dielectric constant (k) materials as interlayer dielectrics (ILDs) between layers of copper interconnects. Unfortunately, these low-k ILDs are too soft to be integrated with conventional chemical mechanical polishing (CMP) technique.

We, and others, have suggested an alternative polishing technique, electrochemical polishing (ECP) as a replacement of CMP:
J. Huo, R. Solanki, and J. McAndrew, “Electrochemical planarization of patterned copper films for microelectronic applications, in “Proceedings of the 22nd Heat Treating Society Conference” and “The 2nd International Surface Engineering Congress”, 15-17 Sep. 2003, Indianapolis, Ind., USA, pp. 389-397.
J. Huo, “Electrochemical planarization of copper for microelectronic application”, doctoral dissertation, (Oregon Health and Science University, Beaverton, Oreg., February, 2004).
J. Huo, R. Solanki, and J. McAndrew, Study of anodic layers and their effects on electropolishing of bulk and electroplated films of copper, Journal of Applied Electrochemistry, vol. 34, no. 3, 305-314, 2004.
D. Padhi, J. Yahalom, S. Gandikota, and G. Dixit, “Planarization of copper films by electropolishing in phosphoric acid for ULSI applications”, J. Electrochem. Soc., V. 150 (1), G10-G14 (2003).
S.-C. Chang, J.-M. Shieh, C.-C. Huang, B.-T. Dai and M.-S. Feng, “Pattern effects on planarization efficiency of Cu electropolishing”, Jpn. J. Appl. Phys. Vol. 41(12), Part 1, 7332-7337(2002).
S. Sato, Z. Yasuda, M. Ishihara, N. Komai, H. Ohtorii, and et al, “Newly developed electrochemical polishing process of copper as replacement of CMP suitable for damascene copper inlaid in fragile low-k dielectrics”, IEEE International Electron Devices Meeting IEDM 2001, Dec. 2-5, 2001, Washington, D.C., USA, 84-87.
M. H. Tsai, S. W. Chou, C. L. Chang, C. H. Hsieha, M. W. Lin, and et al, “CMP-Free and CMP-less approaches for multilevel Cu/low-k BEOL integration”, IEEE International Electron Devices Meeting. Technical Digest, Dec. 2-5, 2001, Washington, D.C., USA, 4.3. 1-4.

There are several challenges for ECP of copper films electroplated on patterned silicon wafers. Gentle surface undulation of the copper film needs to be satisfactorily planarized. Also, macro-uniformity over the entire surface of the wafer, such as a 12″ wafer, should be satisfactory, such as the lack of “islands” (discrete, highly raised portions on the wafer). Moreover, the ECP endpoint needs to be satisfactorily detected and controlled. In other words, one does not want to over or under-planarize the wafer.

ECP can proceed through ohmic, migration and/or diffusion leveling mechanisms. The ohmic leveling mechanism is insignificant under mass-transport limited conditions, which are required in practice to avoid etching along grain boundaries. Migration leveling is relevant when the mass transport limiting species are ions, whereas diffusion leveling is relevant when the mass-transport-limiting species are molecules or ions. The efficiency of migration leveling and diffusion leveling effects both depend on the original geometrical profile of the anode surface to be polished. Sharp points on the surface are evened out faster than blunter features. This is not a problem in most conventional electropolishing applications, where the surface undulations are relatively insignificant and electropolishing is a final step intended to remove sharp, jagged features in order to provide a planar surface. However, in semiconductor manufacturing electropolishing is used to remove relatively gentle undulations that result from previous processing steps, e.g. overfilling of vias and trenches in copper electroplating. Thus the application of copper electropolishing to semiconductor manufacturing requires a different approach from that used in conventional applications.

It is known that ECP is strongly dependent on the surface profiles of the anode to be planarized (J. Huo, “Electrochemical planarization of copper for microelectronic application”, doctoral dissertation, (Oregon Health and Science University, Beaverton, Oreg., February, 2004). One can consider the surfaces of copper films electroplated on patterned silicon wafers to be composed of long wavelength of sine waves, which are difficult to planarize. We have previously suggested that a satisfactory ECP effect in this case requires the formation of anodic layer(s):
J. Huo, R. Solanki, and J. McAndrew, “Electrochemical planarization of patterned copper films for microelectronic applications,” in Proceedings of the 22nd Heat Treating Society Conference and the 2nd International Surface Engineering Congress, 15-17 Sep. 2003, Indianapolis, Ind., USA, pp. 389-397.
J. Huo, “Electrochemical planarization of copper for microelectronic application”, doctoral dissertation, (Oregon Health and Science University, Beaverton, Oreg., February, 2004).
J. Huo, R. Solanki, and J. McAndrew, Study of anodic layers and their effects on electropolishing of bulk and electroplated films of copper, Journal of Applied Electrochemistry, vol. 34, no. 3, 305-314, 2004.

However, it is very challenging to detect and control the surface profile of an anodic layer. We have previously suggested that ECP can also be produced using ohmic leveling under dynamic condition, which is negligible under conventional ECP conditions:
J. Huo, R. Solanki, and J. McAndrew, “Electrochemical planarization of patterned copper films for microelectronic applications,” in Proceedings of the 22nd Heat Treating Society Conference and the 2nd International Surface Engineering Congress, 15-17 Sep. 2003, Indianapolis, Ind., USA, pp. 389-397.
J. Huo, “Electrochemical planarization of copper for microelectronic application”, doctoral dissertation, (Oregon Health and Science University, Beaverton, Oreg., February, 2004).
J. Huo, R. Solanki, and J. McAndrew, Study of anodic layers and their effects on electropolishing of bulk and electroplated films of copper, Journal of Applied Electrochemistry, vol. 34, no. 3, 305-314, 2004.

Thus, those skilled in the art will appreciate a need to addresses the issues that limit ECP.

### SUMMARY

Accordingly, it is an object of the present invention to provide a system and method for performing ECP that satisfactorily achieves macro-uniform planarization (such as the lack of “islands”), over the entire surface of an anode.

It is another object of the present invention to provide a system and method for performing ECP that satisfactorily achieves planarization of gentle surface undulations of the metal coating on the semiconductor wafer resulting from previous processing steps, such as overfilled vias and trenches, i.e., patterned wafers.

The aforesaid objects are achieved individually and/or in combination, and it is not intended that the present invention be construed as requiring two or more of the objects to be combined unless expressly required by the claims attached hereto.

According to the present invention, a system for performing electrochemical planarization of a surface of an anode includes: a means for retaining the anode; a cathode disposed parallel to the anode; a reservoir for containing an electrolyte composition and being operatively associated with said means for retaining and with the cathode; a means for providing a voltage between the anode and the cathode; and a means for rotating one of the anode and the cathode, the cathode having a surface facing the means for retaining, said surface being configured such that the surface does not extend over all of the anode surface to be planarized. Preferably, the anode is a patterned or unpatterned semiconductor wafer with electroplated metal thereon, such as copper.

According to the invention, a method for performing electrochemical planarization of an anode surface includes the following steps. An electrochemical planarization system is provided that includes: 1) a means for retaining the anode; 2) a cathode disposed parallel to the anode; 3) a reservoir for containing an electrolyte composition; 4) a means for rotating either the anode or cathode; and 5) a means for providing a voltage between the anode and the cathode. The reservoir is operative associated with the means for retaining, the means for rotating, and the cathode. The cathode has a surface facing the anode and is configured such that the surface does not extend over all of the anode surface to be planarized when the anode is retained by the means for retaining and rotating. An electrolyte composition is provided within the reservoir.

The anode is retained and one of the anode and cathode is rotated with the means for rotating. A voltage is applied to the anode and the cathode with the means for providing. Electrochemical planarization of the anode surface is allowed to occur until a desired degree of planarization is achieved. Preferably, the anode is a patterned or unpatterned semiconductor wafer with electroplated metal thereon, such as copper.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1a illustrates a schematic of one embodiment of the system of the invention.

FIG. 1b illustrates a schematic of one embodiment of the system of the invention.

FIG. 2 illustrates a schematic of one embodiment of a cathode according to the invention.

FIG. 3 illustrates a schematic of another embodiment of a cathode according to the invention.

FIG. 4 illustrates a schematic of another embodiment of a cathode according to the invention.

FIG. 5 illustrates a schematic of one embodiment of a cathode according to the invention.

FIG. 6 illustrates a mathematical analysis of the uniformity of electrical field application by one embodiment of a cathode according to the invention.

FIG. 7a illustrates copper anodic polarization curves produced by Examples 1-3 and Comparative Example 1.

FIG. 7b illustrates copper anodic polarization curves produced by 5 & 6 and Comparative Example 2.

FIG. 7c illustrates Levich-Koutecky plots of steady-state data obtained from Examples 1 & 4.

FIG. 8a is an image of the planarized anode surface obtained from Comparative Example 3.

FIG. 8b is an image of the planarized anode surface obtained from Example 7.

FIG. 8c is a cross-sectional SEM image of the planarized anode of Comparative Example 4.

FIG. 8d is a cross-sectional SEM image of the planarized anode of Example 8.

FIG. 9 is a graph illustrating the concentration gradient of the anodic layer.

### DESCRIPTION OF PREFERRED EMBODIMENTS

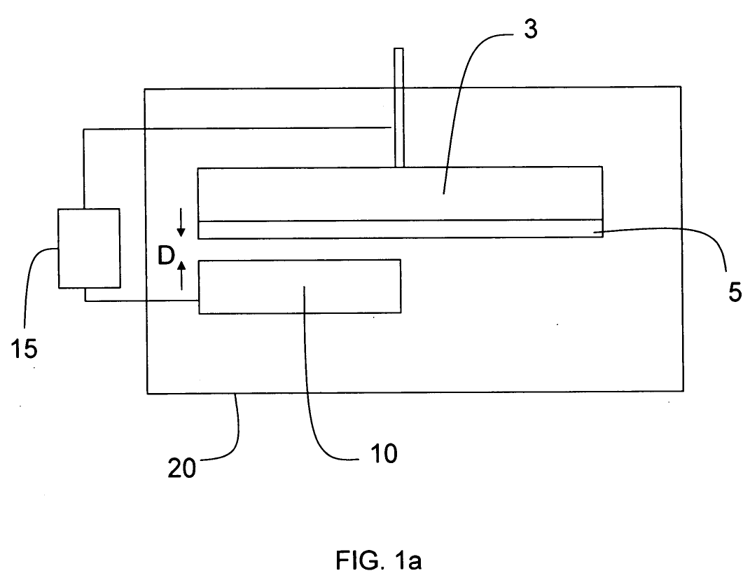

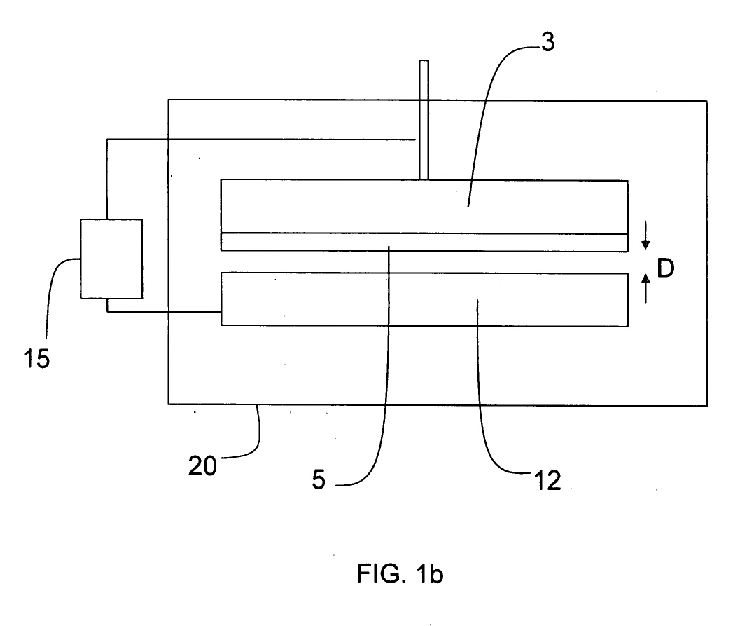

As best illustrated in FIG. 1a, one embodiment of the invention includes means for retaining and rotating 3 the anode to be planarized, 5. A means for applying a voltage 15 applies a voltage to the anode 5 and cathode 10. A reservoir 20 contains electrolyte, which flows in between anode 5 and cathode 10 separated by an interelectrode distance D.

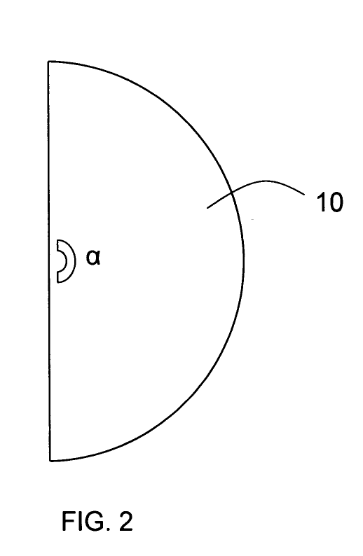

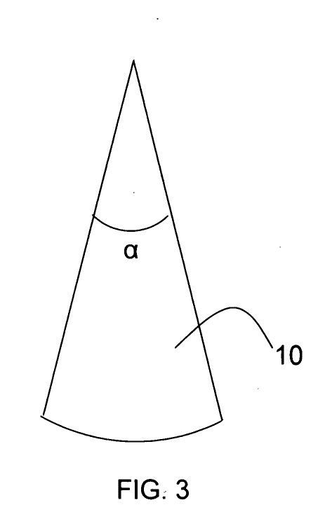

As best shown in the planar top views of FIGS. 2 and 3, cathode 10 may be configured as a segment of a disc. While these illustrative cathode configurations have an angle α of about 180° (FIG. 2) and about 400 (FIG. 3), a may vary from greater than 0° to less than 360°. One of ordinary skill in the art will understand that an optimum α is a function of the degree of electrolyte solution circulation and planarization speed desired.

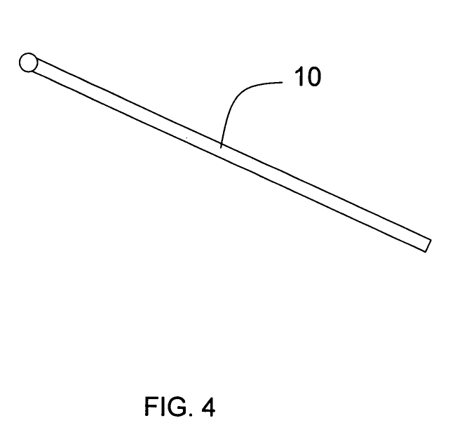

As best shown in the planar, top view of FIG. 4, cathode 10 may be configured as a narrow bar.

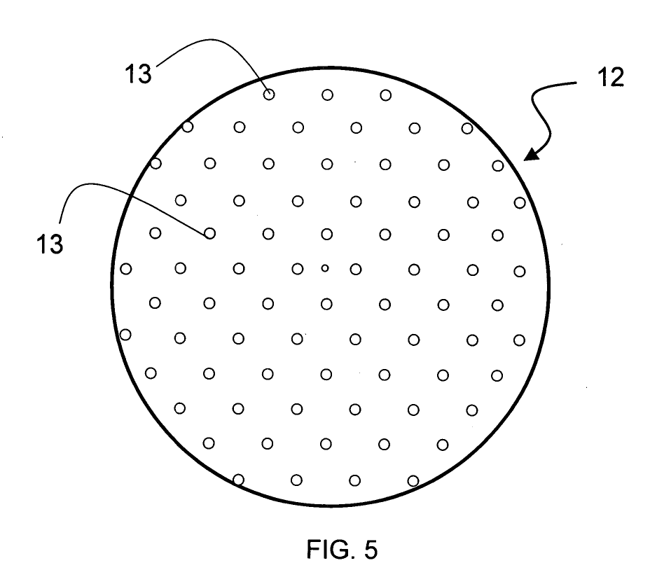

Referring to FIGS. 1b and 5, cathode 12 may be configured as a disc with a plurality of holes 13. While FIG. 5 illustrates cathode 12 as having only about 65 holes 13, preferably the cathode 12 has many multiples of that amount of holes 13, and which are staggeredly positioned over the cathode 12, in order to provide a more uniform electrolyte solution supply and electric field over the surface of the anode 5 as it is rotated during ECP. One of ordinary skill in the art will understand that the holes 13 are also staggeredly positioned such that during rotation, all the points on the anode 5 will experience the same duration of exposure to the cathode 12. One of ordinary skill in the art will understand that an optimum diameter and number of holes will depend upon the strength of the material used for the cathode 12 and upon the degree of electrolyte solution circulation and planarization speed desired.

The thickness of such a cathode 12 is similarly dependent upon the material used for the cathode 12 and upon the pressure of the electrolyte solution. In other words, a pressure drop from a bottom to a top of the cathode 12, or vice versa, for a thicker cathode 12 will be greater than for a thinner cathode 12. Preferably, the material of the cathode 12, electrolyte solution circulation and the thickness of the cathode 12 are selected such that: 1) a uniform electrolyte solution can be provided on the anode surface to be planarized, and 2) metal ions dissolved from the anode and hydrogen atoms or bubbles produced at the cathode can be flushed away from the electrode.

With respect to all embodiments of the invention, instead of rotating the anode 5 while the cathode 10, 12 is fixed, it is well within the scope of the invention to rotate the cathode 10, 12 while the anode 5 is in fixed position.

Preferably, the anode 5 is a semiconductor wafer. Preferably, it is a patterned semiconductor wafer including vias and/or trenches containing copper.

In a conventional ECP system, a solid circular (360°) metal plate serves as cathode 10, 12. When the interelectrode distance between the anode 5 and the cathode 10, 12 is relatively small, poor ECP uniformity will result over an anode 5 because of poor electrolyte solution circulation. Additionally, hydrogen atoms produced on the cathode 10, 12 will more easily reach the surface of the anode 5 with such a low distance such that they form H₂ bubbles thereby causing pits thereupon. These pits cause discontinuity of the metal coating on the anode 5. As a result, islands of metal films will be left on the surface of the anode 5. Thus, for conventional ECP systems it is important to maintain a sufficiently great interelectrode distance D in order to avoid these problems.

In contrast, the inventors have discovered that a relatively low interelectrode distance achieves satisfactory ECP by using the system according to the invention. Because the cathode 10, 12 has a surface that does not extend across the entire area of the portion of the anode 5 to be planarized, the electrolyte solution flow is significantly less impeded as compared to conventional ECP systems. A corollary benefit is that H₂ bubbles tend less to cause pits on the anode surface because they tend to be flushed out by the electrolyte solution recirculation.

The benefit of a relatively low interelectrode distance D is as follows. Under conventional conditions (a large interelectrode distance D), we would expect that the contour of the anodic boundary diffusion layer on the anode 5 will follow the contour of the anode 5 itself. Thus, we would expect there to be little tendency to remove gentle surface undulations from the anode 5 because the depletion rate of the metal coating from a “peak” and from a “valley” should be about the same.

We propose that when the inter-electrode distance D is extremely small, i.e. when the electrodes 5, 10, 12 are sufficiently close that the anodic layer is disrupted, the rotating anode 5 forces the anodic layer to be conformal with the cathode 10, 12. That is, the surface of the anodic layer is flat as long as the surface of the cathode 10, 12 is flat. This will especially provide very good planarization of an anode 5 having a gently undulating surface. The mechanism for this effect is explained below.

The thickness of a an anodic layer during rotation of the anode or cathode, considering only diffusion of the anodic metal cations, is:

$${δ}_{c} = 1.61 {D}^{\frac{1}{3}} {ν}^{\frac{1}{6}} {ω}^{- \frac{1}{2}}$$

Where δ_{c} is the anodic diffusion layer, D is the diffusion coefficient (cm²/s), v=μ/ρ is kinematic viscosity (cm²/s), and ω is angular frequency of anode rotation (s⁻¹).

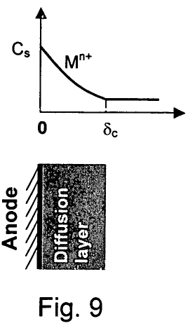

As best illustrated in FIG. 9, the concentration gradient in the anodic layer depends upon the anodic layer thickness for a given anode potential. Where the anodic layer is relatively thinner, the concentration gradient is relatively higher. Since the depletion rate of the metal cations from the surface of the anode 5 depends upon the concentration gradient, a relatively higher concentration gradient at the anodic layer/electrolyte solution interface results in a relatively higher depletion. Conversely, when the anodic layer is relatively thicker, the concentration gradient is relatively lower and the depletion rate of the metal cations from the surface of the anode 5 is similarly relatively lower.

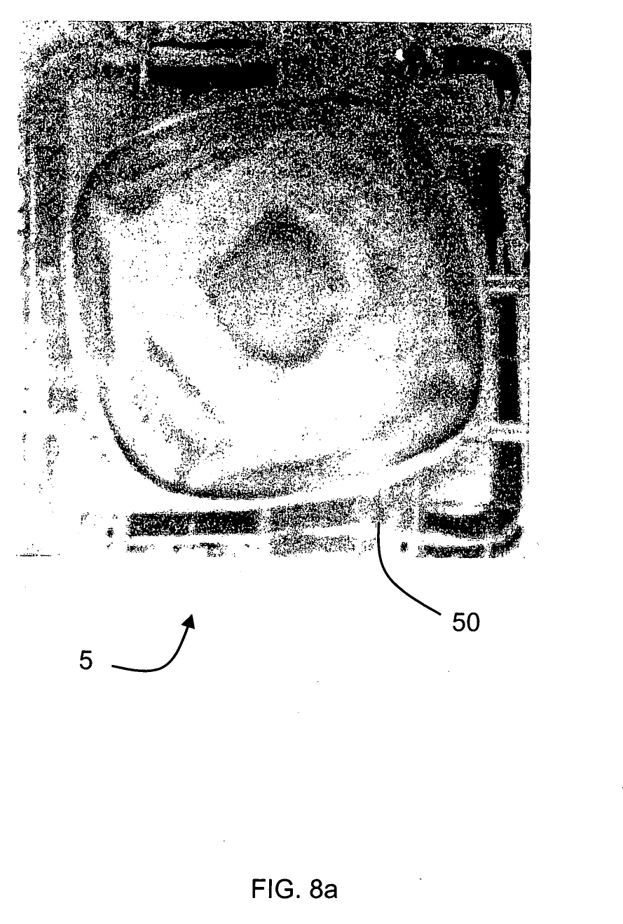

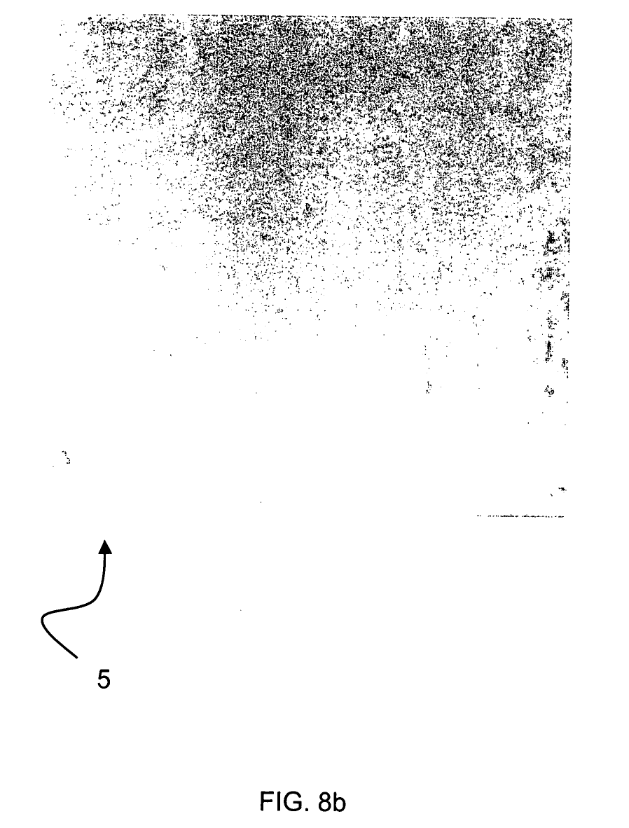

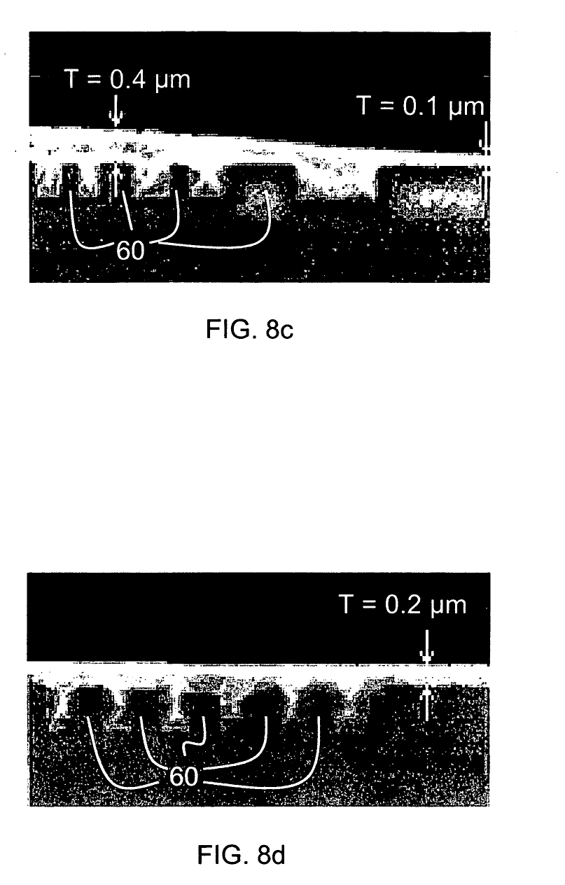

Hence, when the anodic layer is disrupted, such as when a very small interelectrode distance D exists, the shorter distance between the anode 5 and the anodic diffusion layer/electrolyte solution interface at a peak in the surface profile of the anode 5 results in a higher depletion rate than at a valley, and a gently undulating surface is highly planarized in comparison. When the anodic diffusion layer is not disrupted, such as when a very large interelectrode distance exists in convention ECP systems, planarization of a gently undulating surface is unsatisfactorily planarized. This difference is well illustrated in FIGS. 8c and 8d with Comparative Example 4 and Example 8, respectively.

Preferably, the anode 5 and cathode 10, 12 are positioned to yield an interelectrode distance D of less than about 1 mm.

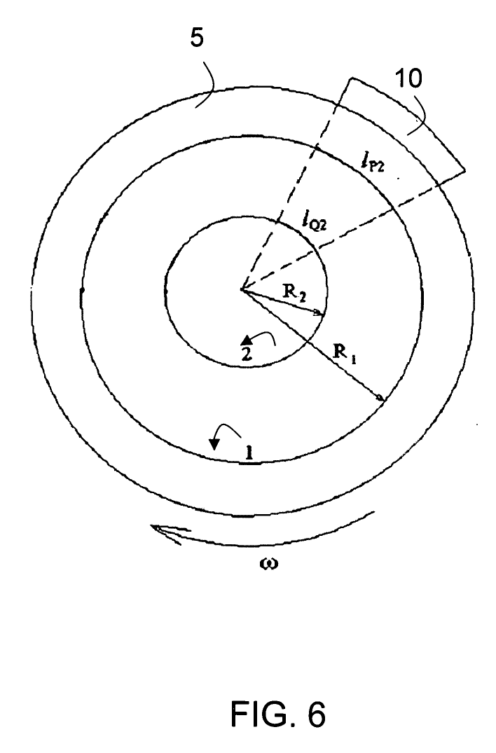

Mathematical analysis suggests that a segment of a disc satisfactorily achieves a highly uniform ECP driving force over the entire surface of the anode 5. As illustrated by FIG. 6, when the cathode 10 (of the embodiment of FIG. 3) rotates with angular speed ω, arbitrary points P (at track 1) & Q (at the intersection of track 2 and the radius from the center and the arbitrary point P) on anode 5 move along tracks 1 and 2 with linear velocity Vₚ=2πωR₁ and V_{Q}=2πωR₂ respectively. P & Q pass cathode 10 for a distance I_{P2}=2πωR₁, I_{Q2}=2πωR₂ and thus face cathode 10 for a period of time t_{P2}=I_{P2}/Vₚ=2πωR₁/2πωR₁=1, t_{Q2}=I_{Q2}=/V_{Q}=2πωR₂/2πωR₂=1. That is, t_{P2}=t_{Q2}. This indicates that all the points on the anode 5 have an equal chance to pass through the cathode 10.

Additionally, two or more of the disc segments of FIG. 3 could be used as the cathode 10. For example, two, three or four wedge-shapes extending radially from a common center rotational axis may be used.

However, the mathematically ideal segment configuration described above is not essential for practice of the invention. In general, any shape less than a full disc may be used so long as there is satisfactory uniformity of ECP driving force upon each point on the surface of the anode 5, such as in the embodiments illustrated in FIG. 4. One of ordinary skill in the art will understand that the width of such a narrow bar configuration will depend upon the electrolyte solution circulation and planarization speed desired.

An interelectrode distance D of essentially just greater than 0 mm may be achieved by moving the anode 5 and cathode 10, 12 towards another until contact is made and then moving them apart, i.e., “backing off”, one of them. It is well within the invention to either hold the anode 5 fixed while the cathode 10, 12 is moved towards it, to hold the cathode 10, 12 fixed while the anode is moved towards it, or to hold neither the anode 5 and cathode 10, 12, but to instead move both of them towards each other.

Positioning the anode 5 and cathode 10, 12 to achieve a desired interelectrode distance D may be performed by providing the cathode 10, 12 with a raised portion at some portion thereof, i.e., a “stop”. The stop of course will have a height equal to or less than the lowest desired interelectrode distance D. Upon movement of the anode 5 and cathode 10, 12 towards one another, the anode 5 will at some point make contact with the stop. At that time, the interelectrode distance equivalent to stop height is achieved. Otherwise, the anode 5 and cathode 10, 12 may be backed off, until the desired interelectrode distance D is achieved. Confirmation of contact may be performed by measuring qualitatively, i.e., moving the anode 5 and cathode 10, 12 together until the operator feels resistance at which time the anode 5 and cathode 10, 12 may be backed off. It is preferably performed by measuring the force applied to the stop. When the measured force spikes upward, contact has been made. A suitable device for positioning the anode or cathode is the Sub-Micron Adjuster MDT216A, available from Thorlabs, Inc. located in Newton, N.J. 07860.

Positioning the electrodes and cathodes to achieve a desired interelectrode distance D may be performed by detecting a spike in electric current from the cathode 10, 12 to the anode 5. In this manner, one may know that the circuit consisting of the device for applying voltage plus the anode 5 and cathode 10, 12 is shorted out. Following confirmation of this contact, the electrical connection may be broken by “backing off” the anode 5 and cathode 10, 12 to the desired interelectrode distance or until the current spike disappears.

### EXAMPLES

The apparatus illustrated in FIG. 1 was used to perform ECP under the following conditions.

The anodes were placed in a circular sample holder with a square window at the bottom. Anodic polarization curves were obtained with Linear Sweep Voltammetry (LSV) with a scan range of 0˜4 V and a scan rate of 5 Mv/sec. A 273A Potentiostat/Galvanostat (Princeton Applied Research) was used to perform the LSV at room temperature.

### Example 1

Anode: copper disc
Cathode: section of copper disc with α=10
Reference electrode: Ag/AgCl in 3M KCl
Electrolyte: 85% H₃PO₄
Solution circulation: with a magnetic stirrer
Anode rotating speed: 100 rpm
Interelectrode distance L=20 mm

### Example 2

Anode: copper disc
Cathode: section of copper disc with α=40
Reference electrode: Ag/AgCl in 3M KCl
Electrolyte: 85% H₃PO₄
Solution circulation: with a magnetic stirrer
Anode rotating speed: 100 rpm
Interelectrode distance L=20 mm

### Example 3

Anode: copper disc
Cathode: section of copper disc with α=90
Reference electrode: Ag/AgCl in 3M KCl
Electrolyte: 85% H₃PO₄
Solution circulation: with a magnetic stirrer
Anode rotating speed: 100 rpm
Interelectrode distance L=20 mm

### Example 4

Anode: copper disc
Cathode: section of copper disc with α=180
Reference electrode: Ag/AgCl in 3M KCl
Electrolyte: 85% H₃PO₄
Solution circulation: with a magnetic stirrer
Anode rotating speed: 100 rpm
Interelectrode distance L=20 mm

### Comparative Example 1

Anode: copper disc
Cathode: solid copper disc, i.e., α=360
Reference electrode: Ag/AgCl in 3M KCl
Electrolyte: 85% H₃PO₄
Solution circulation: with a magnetic stirrer
Anode rotating speed: 100 rpm
Interelectrode distance L=20 mm

### Example 5

Anode: copper disc
Cathode: section of copper disc with α=10
Reference electrode: Ag/AgCl in 3M KCl
Electrolyte: 50% H₃PO₄ and 50% ethylene glycol
Solution circulation: with a magnetic stirrer
Anode rotating speed: 10 rpm
Interelectrode distance L=1 mm

### Example 6

Anode: copper disc
Cathode: section of copper disc with α=10
Reference electrode: Ag/AgCl in 3M KCl
Electrolyte: 50% H₃PO₄ and 50% ethylene glycol
Solution circulation: with a magnetic stirrer
Anode rotating speed: 10 rpm
Interelectrode distance L=50 mm

### Comparative Example 2

Anode: tantalum disc
Cathode: section of copper disc with α=10
Reference electrode: Ag/AgCl in 3M KCl
Electrolyte: 50% H₃PO₄ and 50% ethylene glycol
Solution circulation: with a magnetic stirrer
Anode rotating speed: 100 rpm
Interelectrode distance L=50 mm

### Example 7

Anode: copper-electroplated trenched silicon wafer
Cathode: section of copper disc with α=10
Reference electrode: Ag/AgCl in 3M KCl
Electrolyte: 50% H₃PO₄ and 50% ethylene glycol
Solution circulation: with a magnetic stirrer
Anode rotating speed: 10 rpm
Interelectrode distance: L<1 mm
Process time: 50 s

### Comparative Example 3

Anode: copper-electroplated trenched silicon wafer
Cathode: solid copper disc, i.e., α=360
Reference electrode: Ag/AgCl in 3M KCl
Electrolyte: 50% H₃PO₄ and 50% ethylene glycol
Solution circulation: with a magnetic stirrer
Anode rotating speed: 100 rpm
Interelectrode distance L=1 mm
Process time: 50 s

### Example 8

Anode: copper-electroplated trenched silicon wafer
Cathode: section of copper disc with α=10
Reference electrode: Ag/AgCl in 3M KCl
Electrolyte: 50% H₃PO₄ and 50% ethylene glycol
Solution circulation: with a magnetic stirrer
Anode rotating speed: 10 rpm
Interelectrode distance L<1 mm
Process time: 250 s

### Comparative Example 4

Anode: copper-electroplated trenched silicon wafer
Cathode: solid copper disc, i.e., α=360
Reference electrode: Ag/AgCl in 3M KCl
Electrolyte: 85% H₃PO₄
Solution circulation: with a magnetic stirrer
Anode rotating speed: 100 rpm
Interelectrode distance L=35 mm
Process time: 120 s

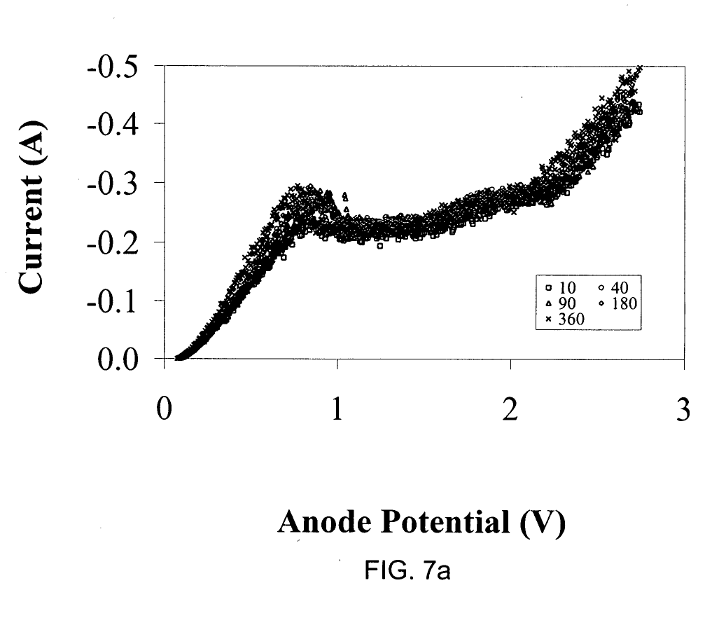

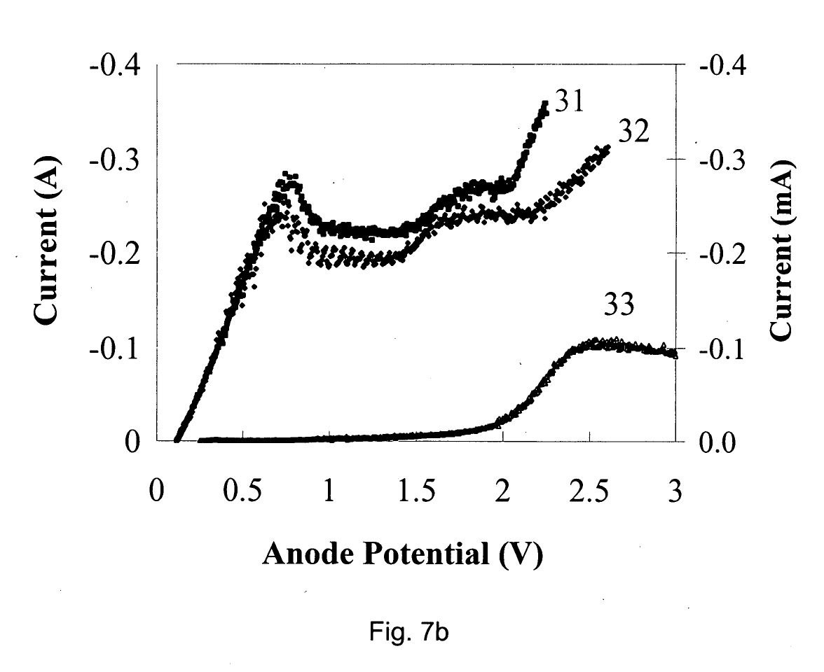

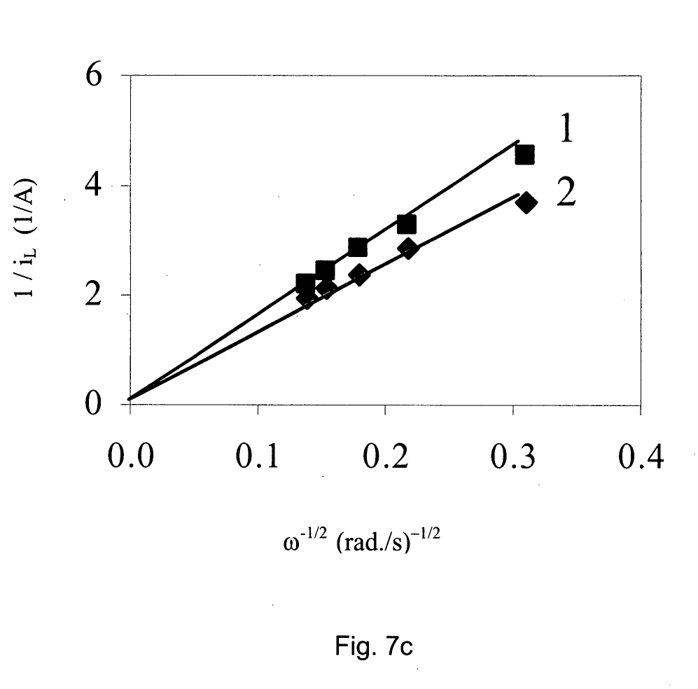

As shown in FIG. 7a, wedge-shaped cathodes, the polarization curves obtained with different sectorial cathodes of Examples 1-3 (angle α of 10°, 40°, 90° and 180°) are almost identical with that obtained with the traditional circular cathode of Comparative Example 1 (angle α of 360°). All the curves have limiting current plateaus, indicating that the process is mass transport controlled.

A more stringent criterion for validating mass transport conditions is when the limiting current obeys the Levich equation (R. Alkire and A. Cangellari, J. Electrochem. Soc., 136, 913 (1989)):

$${i}_{L} = 0.62 {nFA}_{0} {D}^{\frac{2}{3}} {ν}^{- \frac{1}{6}} {ω}^{\frac{1}{2}} ( {C}_{s} - {C}_{b} ) \qquad [ 3 ]$$

where Aₒ is the area of the anode surface, D is Cu diffusion coefficient, v is kinematic viscosity, Cₛ−C_{b} is the concentrations difference of mass transport limiting species between the anode surface and bulk solution. Accordingly, Levich-Koutecky plot (1/i_{L} VS 1/ω^{1/2}) will be a straight line if the process is mass transport controlled. As shown in FIG. 7c, the Levich-Koutecky plots of steady-state data obtained with sectorial cathodes of different angles α of Examples 1 and 4 validate mass transport conditions with the new ECP design.

As shown in FIG. 7b, copper anodic polarization curves 31, 32 obtained using the sectorial cathodes of Examples 5-6 have similar shapes irregardless of the interelectrode distance.

As shown in FIG. 7b, in the range of Cu anodic limiting current plateaus (0.8˜2V) 31, 32, the Ta anodic current density plot 33 is extremely small (<0.5 mA) compared to the Cu anodic current density (about 200 mA or above). Therefore, when excess Cu is removed (i.e., Ta layer is exposed), the current density will drop significantly. This may be used to detect the endpoint of ECP process. The remaining Ta/TaN layers are usually deposited by methods such as CVD and ALD. These layers typically have very flat surfaces. Therefore, there are no planarization issues and they can be easily removed by ECP with different solutions or by purely chemical means (etching).

As shown in FIG. 8a, the conventional ECP system with the cathode of comparative example 3 preferentially removed copper from the edge 50 of the wafer at a close interelectrode distance (D=1 mm). We believe this is due to poor solution circulation.

In contrast and as shown in FIG. 8b, the cathode of example 7 resulted in macro-uniform removal of copper from the wafer.

Increasing the interelectrode distance can improve solution circulation and thus the macro-uniformity of copper removal for conventional ECP systems. However, planarization of undulating features on a patterned wafer is very poor. The results of Comparative Example 4, as shown in FIG. 8c, the copper film over the area with trenches 60 is much thicker (0.4 μm) than that over the area without trenches or vias (0.1 μm).

In contrast, the results of Example 8 as shown in FIG. 8d, copper was uniformly removed from areas with trenches 60 and areas without trenches by using the cathode/conditions of example 8.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

1. A system for performing electrochemical planarization of an anode surface, said system comprising:
a) a means for retaining the anode;
b) a cathode disposed opposite to the means for retaining;
c) a reservoir for containing an electrolyte composition and being operatively associated with said means for retaining and with said cathode;
d) a means for providing a voltage between the anode and said cathode; and
e) means for rotating one of the anode and said cathode, the cathode having a surface facing said means for retaining, said cathode surface being configured such that said cathode surface does not extend over all of the anode surface to be planarized.

2. The system of claim 1, wherein said cathode is further configured to provide a substantially uniform driving force to all portions of the anode surface to be planarized during rotation of said one of the anode and said cathode.

3. The system of claim 1, wherein:
a) said cathode is further configured as a segment of a disc having a center, a circumferential edge, and two radial sides extending from said center to said circumferential edge;
b) said means for rotating is configured to rotate said one of the anode and said cathode about a rotational axis; and
c) said disc segment center lies within the rotation axis.

4. The system of claim 1, wherein:
a) said cathode is further configured as a plurality of wedges, each of said wedges having a circumferential edge, a center common to each of said wedges, and two radial sides extending from said circumferential edge to said center;
b) said means for rotating is configured to rotate said one of the anode and said cathode about a rotational axis; and
c) said wedge center lies within the rotation axis.

5. The system of claim 1, wherein said cathode is further configured as a narrow bar, said bar having a length extending to a circumferential edge of the metal coating such that said cathode provides a substantially uniform driving force to all portions of anode surface to be planarized during rotation of said one of the anode and said cathode.

6. The system of claim 3, wherein an angle defined by said center and radial sides is less than about 360°.

7. The system of claim 4, each of said wedges has an angle defined by said center and radial sides which is no less than about 360°/n wherein n is the total number of wedges in said plurality.

8. The system of claim 1, further comprising
a) a means for selectively moving the anode and said cathode apart or towards each other;
b) an element for establishing a desired distance between the anode and said cathode and being operatively associated with said means for selectively moving;
c) a force detector for detecting a force applied by said means for selectively moving onto said element for establishing, thereby establishing said desired distance.

9. The system of claim 8, further comprising a force detector wherein:
a) said cathode includes a raised portion on said surface;
b) said means for selectively adjusting is configured to allow contact between the anode and said raised portion after selective adjustment of the distance is performed; and
c) said force detector is configured to detect a force applied to said raised portion by the anode upon contact between the anode and said cathode.

10. The system of claim 1, further comprising
a) a means for selectively moving the anode and said cathode apart or towards each other;
b) an element for establishing a desired distance between the anode and said cathode and being operatively associated with said means for selectively moving; and c) a current detector for deriving a current spike between the anode and said cathode.

11. The system of claim 8, wherein said distance is no greater than about 1 mm.

12. The system of claim 1, wherein the anode is a semiconductor wafer with a layer of copper electroplated thereon.

13. The system of claim 2, wherein the anode is a semiconductor wafer with a layer of copper electroplated thereon.

14. The system of claim 3, wherein the anode is a semiconductor wafer with a layer of copper electroplated thereon.

15. The system of claim 4, wherein the anode is a semiconductor wafer with a layer of copper electroplated thereon.

16. The system of claim 5, wherein the anode is a semiconductor wafer with a layer of copper electroplated thereon.

17. The system of claim 6, wherein the anode is a semiconductor wafer with a layer of copper electroplated thereon.

18. The system of claim 7, wherein the anode is a semiconductor wafer with a layer of copper electroplated thereon.

19. A method of performing electrochemical planarization of a surface of an anode comprising the steps of:
a) providing an electrochemical planarization system comprising:
i) a means for retaining the anode;
ii) a cathode disposed parallel to the anode;
iii) a reservoir for containing an electrolyte composition and being operative associated with the means for retaining and rotating and the cathode;
iv) means for rotating one of the anode and cathode; and
v) a means for providing a voltage between the anode and the cathode, the cathode having a surface facing the rotational plane and being configured such that the cathode surface does not extend over all of the anode surface to be planarized when the anode is retained by the means and one of the anode and cathode are being rotated;
b) providing an electrolyte composition within the reservoir;
c) rotating the anode or cathode with the means for rotating;
d) applying a voltage to the anode and the cathode with the means for providing; and
e) allowing electrochemical planarization of the anode surface to occur until a desired degree of planarization is achieved.

20. The method of claim 19, further comprising the step of positioning at least one of the cathode, anode and means for retaining and rotating such that a distance between the cathode and the anode is no more than about 1 mm.

21. The method of claim 19, wherein the anode is patterned.

22. The method of claim 19, wherein:
a) the cathode is further configured as a disc segment having a circumferential edge, a center and two radial sides extending from the circumferential edge to the center;
b) the means for retaining and rotating is configured to rotate the anode about a rotational axis; and
c) the disc segment center lies within the rotation axis.

23. The method of claim 19, wherein:
a) the cathode is further configured as a plurality of wedges, each of the wedges having a circumferential edge, a center common to each of the wedges and two radial sides extending from the circumferential edge to the center;
b) the means for retaining and rotating is configured to rotate the anode about a rotational axis; and
c) the wedge center lies within the rotation axis.

24. The method of claim 19, wherein the cathode is further configured as a narrow bar having a length extending to a circumferential edge of the anode surface to be planarized such that the cathode provides a substantially uniform driving force to all portions of the anode surface to be planarized during the rotation and the application of the voltage.

25. The method of claim 22, wherein an angle defined by the center and radial sides is less than about 360°.

26. The method of claim 23, each of said wedges has an angle defined by said center and radial sides which is less than about 360′/n wherein n is the total number of wedges in said plurality.

27. The method of claim 19, wherein the desired degree of planarization is determined by a upward or downward spike in detected current between the anode and the cathode thereby indicating dissolution of a layer underlying the surface of the anode.

28. The method of claim 19, wherein the anode is a semiconductor wafer with a layer of copper electroplated thereon.

29. The method of claim 22, wherein the anode is a semiconductor wafer with a layer of copper electroplated thereon.

30. The method of claim 23, wherein the anode is a semiconductor wafer with a layer of copper electroplated thereon.

31. The method of claim 24, wherein the anode is a semiconductor wafer with a layer of copper electroplated thereon.
